(19) United States
(12) Patent Application Publication
(10) Pub. No.: US 2025/0164732 A1
(43) Pub. Date: May 22, 2025

(54) CABLE SEALING ARRANGEMENT FOR AN ENCLOSURE

(71) Applicant: CommScope Technologies LLC, Hickory, NC (US)

(72) Inventors: Roel Modest Willy BRYON, Aarschot (BE); Johan GEENS, Bunsbeek (BE); Philippe COENEGRACHT, Hasselt (BE); Peter H.R. VAN MEEUWEN, Tessenderlo (BE)

(73) Assignee: CommScope Technologies LLC, Hickory, NC (US)

(21) Appl. No.: 18/840,310

(22) PCT Filed: Feb. 17, 2023
(86) PCT No.: PCT/US2023/062866

§ 371 Date: Aug. 21, 2024

Related U.S. Application Data
(60) Provisional application No. 63/312,320, filed on Feb. 21, 2022.

(51) Int. Cl. G02B 6/44

(52) U.S. Cl. CPC G02B 6/44775

(57) ABSTRACT

The present disclosure relates to an enclosure having a perimeter sealing arrangement. The enclosure includes a containment structure such as an elastomeric cup that assists in positioning sealant of the perimeter sealing arrangement at different levels.

### CROSS-REFERENCE TO RELATED APPLICATION

This application is being filed on Feb. 17, 2023, as a PCT International application and claims the benefit of and priority to U.S. Provisional Application Ser. No. 63/312,320, filed Feb. 21, 2022, the disclosure of which is hereby incorporated by reference in its entirety.

### BACKGROUND

Telecommunications systems typically employ a network of telecommunications cables capable of transmitting large volumes of data and voice signals over relatively long distances. The telecommunications cables can include fiber optic cables, electrical cables, or combinations of electrical and fiber optic cables. A typical telecommunications network also includes a plurality of telecommunications enclosures integrated throughout the network of telecommunications cables. The telecommunications enclosures are adapted to house and protect telecommunications components such as splices, termination panels, power splitters, and wavelength division multiplexers. It is often preferred for the telecommunications enclosures to be re-enterable. The term “re-enterable” means that the telecommunications enclosures can be re-opened to allow access to the telecommunications components housed therein without requiring the removal and destruction of the telecommunications enclosures. For example, certain telecommunications enclosures can include separate access panels that can be opened to access the interiors of the enclosures and then closed to re-seal the enclosures. Other telecommunications enclosures take the form of elongated sleeves formed by wrap-around covers or half-shells having longitudinal edges that are joined by clamps or other retainers. Still other telecommunications enclosures include two half-pieces that are joined together through clamps, or other structures. Further enclosures include domes attached to bases via clamps. Telecommunications enclosures are typically sealed to inhibit the intrusion of moisture or other contaminants. Example cable sealing arrangements for enclosures are disclosed by PCT International Publication Numbers WO 2014/005916: WO 2017/167819: WO 2018/048910: WO 2019/160995: WO 2019/173663; and WO 2021/096859.

### SUMMARY

One aspect of the present disclosure relates to an enclosure having a perimeter sealing arrangement. The enclosure includes a molded plastic housing including first and second housing pieces that fit together to enclose an interior of the molded plastic housing. The perimeter sealing arrangement of the enclosure is configured to provide sealing between the first and second housing pieces about a perimeter of the molded plastic housing when the first and second housing pieces are fitted together. The perimeter sealing arrangement includes a sealant-receiving region defined by the first housing piece. The sealant-receiving region includes a sealing channel portion defined by a channel-defining portion of the first housing piece and a cable pass-through pocket portion defined by a pocket-defining portion of the first housing piece. The channel-defining portion defines a channel upper boundary. The second housing piece defines a perimeter sealing rib configured to project into the sealing channel portion of the sealant-receiving region of the first housing piece when the first and second housing pieces are fitted together. The enclosure also includes an elastomeric cup positioned in the cable pass-through pocket portion of the sealant-receiving region. The elastomeric cup includes a cup wall defining a cup upper boundary that is higher than the channel upper sealant boundary. The cup wall is positioned to separate the cable pass-through pocket portion from the sealing channel portion. The enclosure further includes sealant gel positioned within the sealing channel portion and the elastomeric cup. The sealant gel in the elastomeric cup has an upper surface set at a higher level than the sealant gel in the sealing channel portion.

Another aspect of the present disclosure relates to a method for open casting sealant for a perimeter sealing arrangement of an enclosure. The perimeter sealing arrangement includes a sealant-receiving region defined by a molded plastic housing of the enclosure. The sealant-receiving region includes a sealing channel portion defined by a channel-defining portion of the molded plastic housing and a cable pass-through pocket portion defined by a pocket-defining portion of the molded plastic housing. The channel-defining portion defines a channel upper boundary. The method includes positioning an elastomeric cup in the cable pass-through pocket portion. The elastomeric cup includes a cup wall defining a cup upper boundary that is higher than the channel upper boundary when the elastomeric cup is positioned within the cable pass-through pocket portion. When the elastomeric cup is positioned within the cable pass-through pocket portion the cup wall separates the cable pass-through pocket portion from the sealing channel portion. The method also includes filling the sealing channel portion and the elastomeric cup with liquid sealant with the liquid sealant in the elastomeric cup being filled to a level higher than the liquid sealant in the sealing channel portion. During filling, the cup wall prevents the liquid sealant in the elastomeric cup from flowing into the sealing channel portion such that the liquid sealant in the elastomeric cup remains at the level higher than the liquid sealant in the sealing channel portion. The method also includes curing the liquid sealant to set cured sealant in the elastomeric cup at the level higher than cured sealant in the sealing channel portion.

A variety of additional aspects will be set forth in the description that follows. The aspects can relate to individual features and to combinations of features. It is to be understood that both the foregoing general description and the following detailed description are exemplary and explanatory only and are not restrictive of the broad inventive concepts upon which the examples disclosed herein are based.

### BRIEF DESCRIPTION OF THE DRAWINGS

The following drawings are illustrative of particular examples of the present disclosure and therefore do not limit the scope of the present disclosure. Examples of the present disclosure will hereinafter be described in conjunction with the appended drawings, wherein like numerals denote like elements.

FIG. 1 depicts a telecommunications enclosure having a perimeter sealing arrangement in accordance with the principles of the present disclosure.

FIG. 2 is a cross-sectional view taken along section line 2-2 of FIG. 1.

FIG. 3 is a cross-sectional view cut through a cable sealed within a cable pass-through location of the telecommunications enclosure of FIG. 1.

FIG. 4 is a perspective view of an elastomeric cup in accordance with the principles of the present disclosure having a first size.

FIG. 5 is a perspective view of an elastomeric cup in accordance with the principles of the present disclosure having a second size.

FIG. 6 is a perspective view of an elastomeric cup in accordance with the principles of the present disclosure having a third size.

FIG. 7 is a perspective view of the telecommunications enclosure of FIG. 1 in an open position with elastomeric cups mounted at the cable pass-through locations but prior to sealing gel being molded within sealing perimeter channels of the enclosure.

FIG. 8 is an enlarged view showing one of the elastomeric cups mounted within a cable pass-through pocket portion.

FIG. 9 is a plan view of another telecommunications enclosure in accordance with the principles of the present disclosure, the enclosure having a modified snap-fit arrangement for latching the enclosure in a closed position.

FIG. 10 is a perspective view of another telecommunications enclosure in accordance with the principles of the present disclosure.

FIG. 11 is a perspective view of still another telecommunications enclosure in accordance with the principles of the present disclosure.

FIG. 12 is a perspective view showing an alternative elastomeric cup in the process of being installed within a cable pass-through pocket portion of an enclosure.

FIG. 13 depicts the elastomeric cup of FIG. 12 installed within the cable pass-through pocket portion.

FIG. 14 is a perspective view showing an alternative elastomeric cup in the process of being installed within a cable pass-through pocket portion of an enclosure.

FIG. 15 depicts the elastomeric cup of FIG. 14 installed within the cable pass-through pocket portion.

FIG. 16 depicts a further elastomeric cup in accordance with the principles of the present disclosure.

FIG. 17 depicts another elastomeric cup in accordance with the principles of the present disclosure.

FIG. 18 depicts a further elastomeric cup in accordance with the principles of the present disclosure.

FIG. 19 depicts an additional elastomeric cup in accordance with the principles of the present disclosure.

### DETAILED DESCRIPTION

Various examples will be described in detail with reference to the drawings, wherein like reference numerals represent like parts and assemblies throughout the several views.

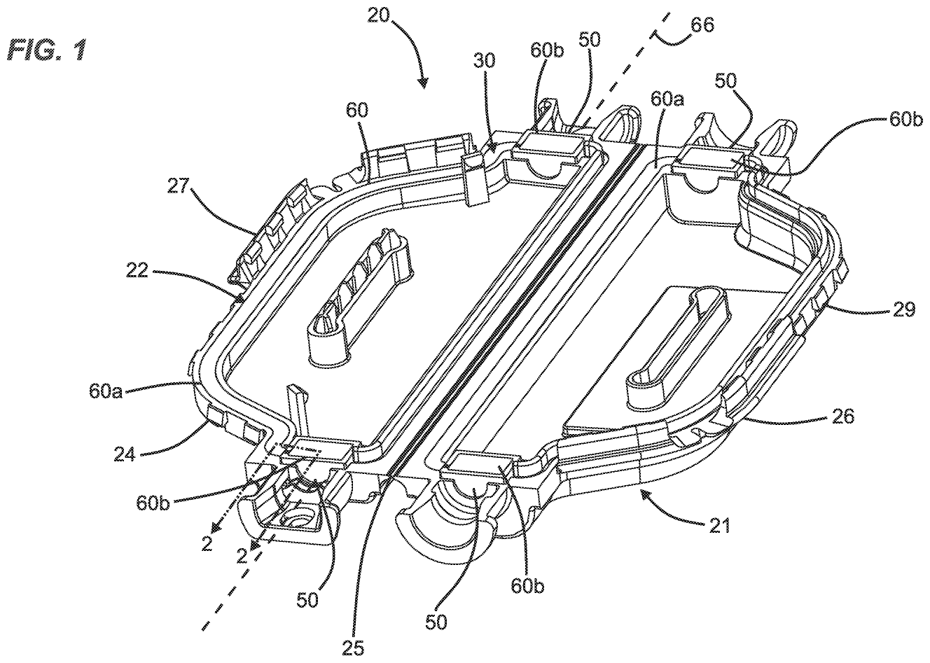

FIG. 1 depicts a telecommunications enclosure 20 having a perimeter sealing arrangement 22 in accordance with the principles of the present disclosure. The telecommunications enclosure 20 is preferably a re-enterable enclosure that includes a housing 21 including first and second housing pieces 24, 26 that define an interior for housing telecommunications components such as fiber optic splices, passive optical power splitters, wavelength division multiplexers, optical taps, fiber optic adapters, fiber optic connectors, fiber management trays, cable loop storage locations, and other components. When the first and second housing pieces 24, 26 are fitted (e.g., mounted, secured, latched) together, the interior of the enclosure 20 is preferably environmentally sealed. The first and second housing pieces 24, 26 can be separated from one another to provide access to the interior of the housing 21. In the depicted example, the housing pieces 24, 26 are connected together by a hinge 25 such as a living hinge that allows the housing pieces 24, 26 to be relatively pivoted to move the housing 21 between open and closed positions. Other types of hinges can also be used. In still other examples, the housing pieces can be separate pieces configured to disconnect from one another when the housing is opened. In certain examples, the housing pieces can be secured in the closed position by latches, clamps, fasteners or the like. In the depicted example, the housing pieces 24, 26 can be secured together by a latching arrangement including sets of snap-fit latches 27 and corresponding catches 29 spaced about a section of the perimeter of the housing that is positioned opposite from the hinge 25.

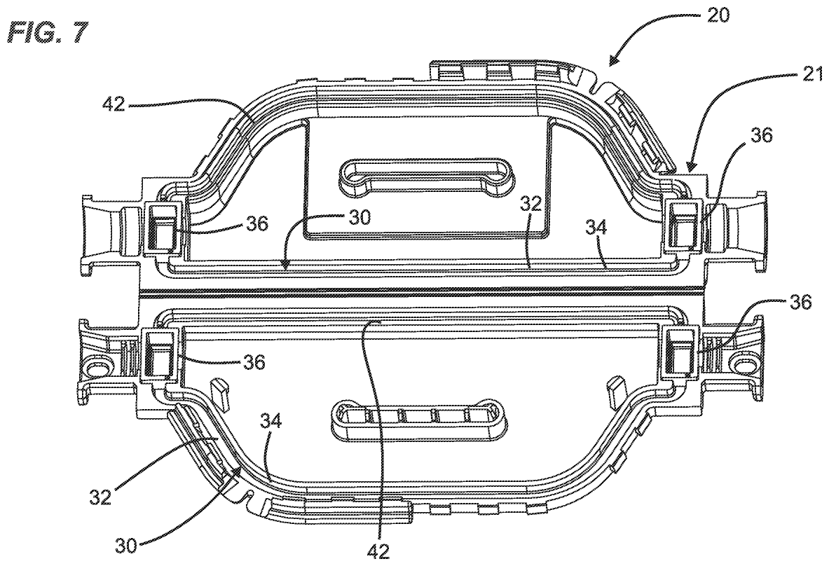

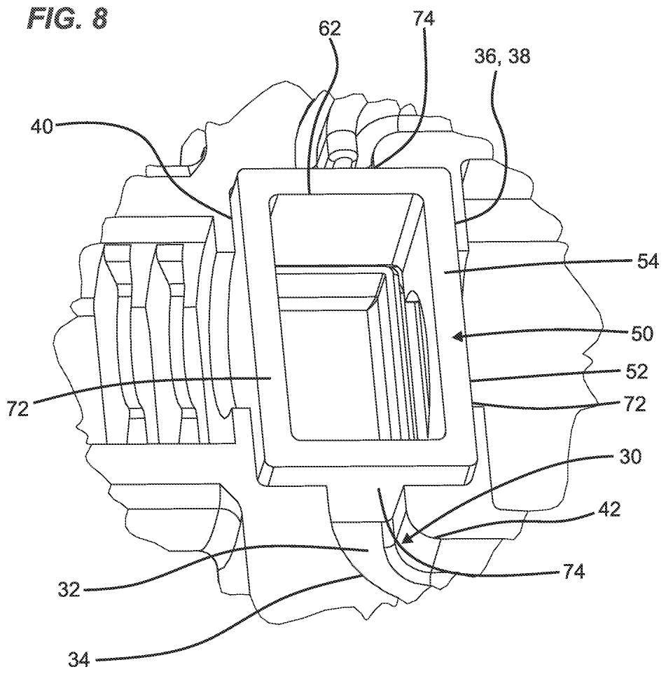

In one example, the housing 21 has a molded plastic construction. The perimeter sealing arrangement 22 of the enclosure 20 is configured to provide sealing between the first and second housing pieces 24, 26 about the perimeter of the housing 21 when the first and second housing pieces 24, 26 are fitted together. The perimeter sealing arrangement includes sealant-receiving regions 30 (see FIGS. 7 and 8) defined by the first and second housing pieces 24, 26. The sealant-receiving regions 30 include sealing channel portions 32 defined by channel-defining portions 34 of the housing pieces 24, 26. The sealant-receiving regions 30 also include cable pass-through pocket portions 36 defined by pocket-defining portions 38 of the housing pieces 24, 26. The pocket-defining portions 38 define pocket upper boundaries 40 (see FIG. 8) and the channel-defining portions 34 define channel upper boundaries 42 (see FIG. 8). The perimeter sealing arrangement 22 further includes perimeter sealing ribs 44 defined by the housing pieces 24, 26 which are arranged to extend about the perimeter of the housing 21. The perimeter sealing rib 44 of the first housing piece 24 is configured to project into the channel-defining portion 34 of the second housing piece 26 when the first and second housing pieces 24, 26 are fitted together to close the housing 21. Similarly, the perimeter sealing rib 44 of the second housing piece 26 is configured to project into the channel-defining portion 34 of the first housing piece 24 when the first and second housing pieces 24, 26 are fitted together to close the housing 21.

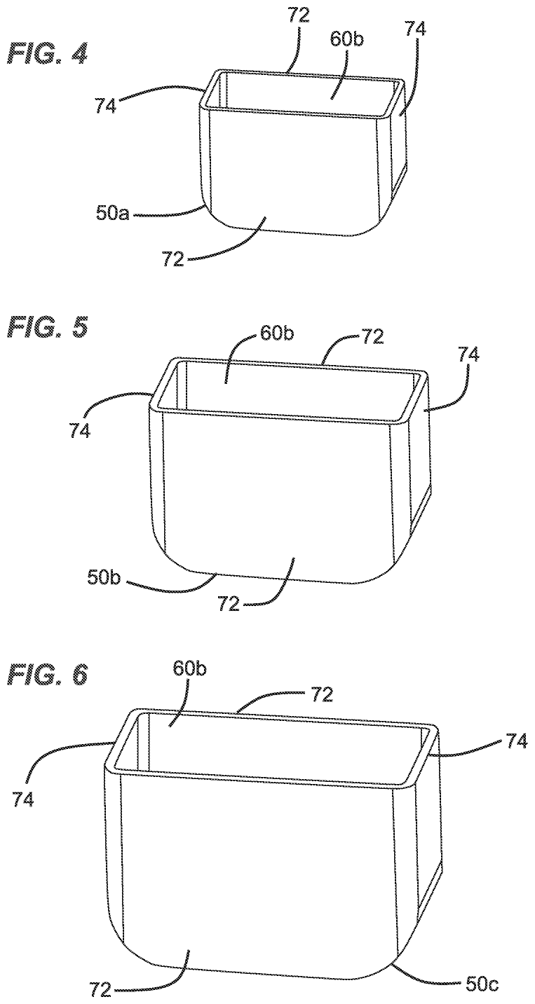

The perimeter sealing arrangement 22 further includes elastomeric cups 50 positioned in the cable pass-through pocket portions 36 of the sealant-receiving regions 30 of the first and second housing pieces 24, 26. The elastomeric cups 50 include cup walls 52 defining cup upper boundaries 54. The elastomeric cups 50 are sized and shaped such that when the elastomeric cups 50 are positioned within the cable pass-through pocket portions 36 of the housing pieces 24, 26, the upper cup boundaries 54 are higher than the pocket upper boundaries 40 and the channel upper boundaries 42 of the housing piece 24, 26 in which the elastomeric cups 50 are mounted. With the elastomeric cups 50 positioned within the cable pass-through pocket portions 36, the cup walls 52 are positioned to separate the cable pass-through pocket portions 36 from adjacent ones of the channel-defining portions 34. In certain examples, the elastomeric cups 50 can have open tops and open bottoms. In certain examples, the elastomeric cups 50 can have open tops and closed bottoms. The cup walls 52 can extend from the open tops to the open or closed bottoms. As shown at FIGS. 4-6, the elastomeric cups 50 can be molded in different sizes (e.g., see elastomeric cups 50a, 50b, and 50c having different sizes) to correspond to different sized cable pass-through pocket portions provided in different enclosures to accommodate sealing of different ranges of cable size (e.g., different ranges of cable diameter).

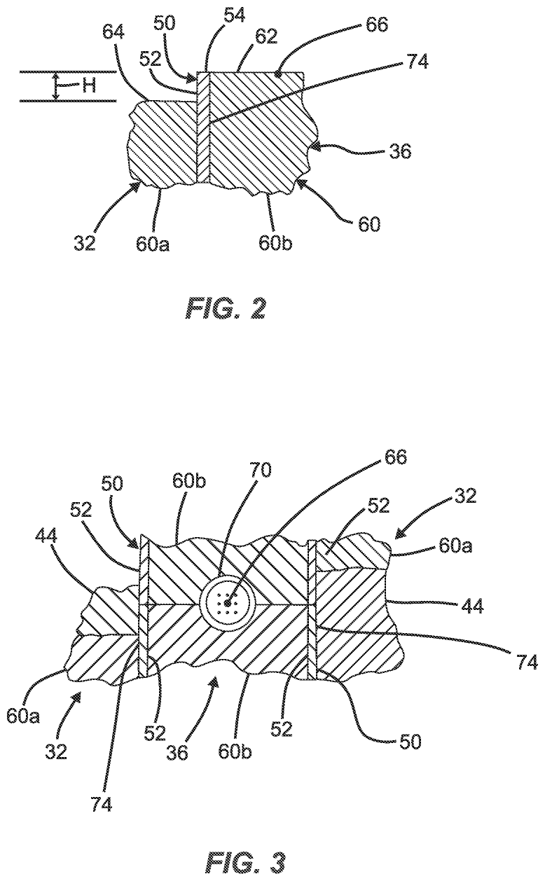

The perimeter sealing arrangement 22 further includes sealant gel 60 positioned within the sealing channel portions 32 and the elastomeric cups 50. For example, the sealant gel 60 includes gel portions 60a positioned in the sealing channel portions 32 and gel portions 60b positioned within the elastomeric cups 50. The gel portions 60b in the elastomeric cups 50 have upper surfaces 62 set at a higher level than upper surfaces 64 of the sealant gel portions 60a in the sealing channel portions 32. For example, with the housing 21 opened and laid flat as shown at FIG. 1, the elastomeric cups 50 support the gel portions 60b such that the upper surfaces 62 are at a higher elevation than the upper surfaces 64 of the gel portions 60a. For example, a height difference H (e.g., a stagger or offset distance as shown at FIG. 2) measured in a direction perpendicular to a cable pass-through axis 66 is defined between the upper surfaces 62 of the gel portions 60b and the upper surfaces 64 of the gel portions 60a. The upper surfaces 62 can also be referred to as cable sealing surfaces or cable sealing faces.

The cable pass-through pocket portions 36 correspond to cable pass-through locations of the enclosure 20 at which cables 70 (see FIG. 3) can be routed in a sealed manner through the perimeter sealing arrangement and into an interior of the housing 21. The cables 70 can be routed along cable pass-through axes 66 (see FIGS. 1-3) that extend through the cable pass-through locations. The cup walls 52 of the elastomeric cups 50 can include end portions 72 that extend across the cable pass-through axes 66 and side portions 74 that extend along the cable pass-through axes 66. The side portions 74 function as dividers for separating the cable pass-through pocket portions 36 from the sealing channel portions 32. Thus, the side portions 74 separate the gel portions 60a from the gel portions 60b. The end portions 72 of the cup walls 52 provide inner and outer axial containment of the gel portions 60b.

To route one of the cables 70 into the housing 21, the housing 21 is opened as shown at FIG. 1, and the cable 70 is laid along the cable pass-through axis 66 across the sealing surface 62 of the gel portion 60b contained within one of the elastomeric cups 50 corresponding to one of the housing pieces 24, 26 (e.g., the first housing piece 24). Once the cable 70 is laid over the sealing surface 62 of the gel portion 60b, the housing 21 can be closed such that the cable 70 is captured between the sealing surface 62 of the gel portion 60b of the first housing piece 24 and the sealing surface 62 of a corresponding gel portion 60b supported by one of the elastomeric cups 50 installed in the second housing piece 26. As the housing 21 is closed, the gel portions 60b deform to allow the sealing surfaces 62 to conform with the exterior of the cable 70 (see FIG. 3). The excess height H at the elastomeric cups 50 provides for enhanced pressurization and deformation of the gel portions 60b to assist the gel portions 60b in effectively sealing about the cable 70. The opposing sealing surfaces 62 seal against one another and against the exterior of the cable 70 to effectively seal the cable pass-through location. During closing of the housing pieces 24, 26 about the cable 70, the cup wall 52 also deforms to receive the cable 70 and to accommodate displacement of excess portions of the gel portions 60b. For example, the end portions 72 of the cup walls 52 can elastically deform axially outwardly and inwardly to accommodate displacement and maintain containment of the gel portions 60b as the housing 21 is closed. In certain examples, the end portions 72 of the cup walls can generally conform to the outer shape of the cable 70 once the housing 21 is closed. When the housing 21 is closed, the perimeter sealing rib 44 of the first housing piece 24 embeds within the gel portion 60a contained within the sealing channel portion 32 of the second housing piece 26 to provide perimeter sealing. Similarly, the perimeter sealing rib 44 of the second housing piece 26 embeds within the gel portion 60a contained within the sealing channel portion 32 of the first housing piece 24 to provide perimeter sealing.

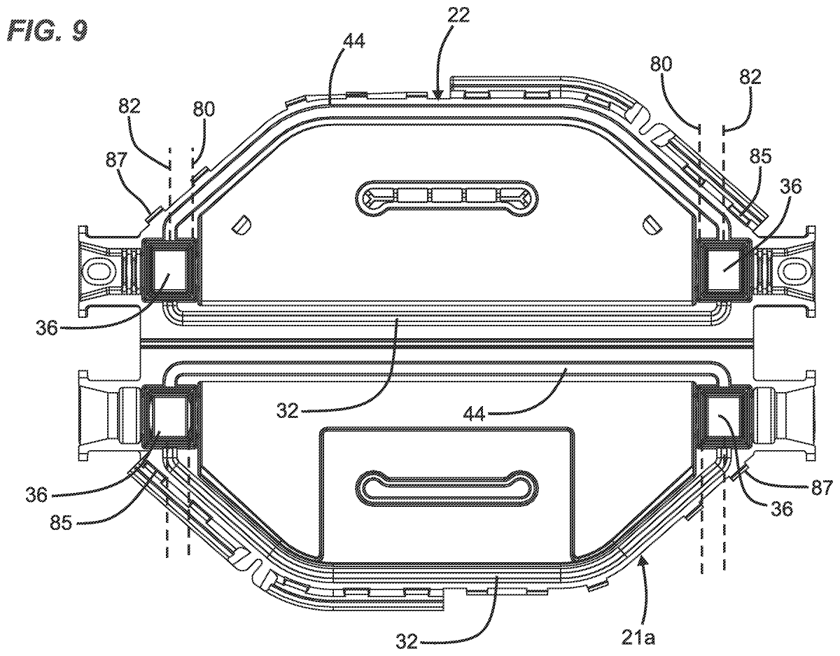

Once closed, the housing pieces 24, 26 can be secured together in the closed state by engaging the latching arrangement including the snap-fit latches 27 and corresponding catches 29. The latching arrangement can retain the pocket-defining portions 38 in close proximity to one another such that the gel portions 62b are adequately pressurized to effectively conform and seal about the cable 70. As shown at FIG. 7, the latches and catches 27, 29 are uniformly positioned along the portion of the housing perimeter positioned opposite from the hinge at a region between the locations of the elastomeric cups 50. In this example, the outermost latches and catches of the latching arrangement do not axially overlap the cable pass-through pocket portions 36. In other words, the outermost latches and catches of the latching arrangement do not extend axially outwardly past the locations of inner axial boundaries 80 of the cable pass-through pocket portions 36. To provide enhanced latching/clamping force between the housing pieces 24, 26 at the cable pass-through pocket portions 36 for adequately pressurizing the gel portions 62b, the latching arrangement can be extended to extend axially outwardly past the inner axial boundaries. For example, FIG. 9 depicts an alternative housing 21a in which the latching arrangement extends axially outwardly past the inner axial boundaries 80 of the cable pass-through pocket portions 36. As depicted at FIG. 9, the latching arrangement extends axially outwardly past axial mid-lines 82 of the cable pass-through pocket portions 36. For example, outermost sets of latches 85 and catches 87 are located at least partially axially outwardly beyond the mid-lines 82.

Aspects of the present disclosure also relate to methods for incorporating sealant of a perimeter sealing arrangement (e.g., the perimeter sealing arrangement 22) into sealant-receiving regions (e.g., the sealant-receiving regions 30) of a housing (e.g., housing 21). In certain examples, the methods can include molding processes such as open cast molding processes in which a sealant is applied as a liquid into at least a portion of the sealant-receiving regions and then cured. In certain examples, elastomeric cups (e.g., elastomeric cups 50) are used as part of the open cast molding process to allow the sealing material to be molded at different heights/levels. For example, the elastomeric cups can include walls that serve a dividing function that separates the sealant-receiving regions into separate sections that can be filled with sealant to different levels. The dividing walls prevent liquid sealant from the region filled to a higher level from flowing into the region filled to a lower level. The elastomeric cups themselves can be pre-formed (e.g., pre-molded) prior to installation in the housing. Also, the elastomeric cups can be prefilled with sealant prior to installation in the housing or can be filled with sealant after installation in the housing as part of the cast molding process. When the elastomeric cups are pre-filled with sealant, the sealant can be cured before the elastomeric cups are installed in the housing.

To position the sealant gel 60 in the sealant receiving regions 30 of the housing 21, the housing 21 (which has been pre-molded and preferably has a polymeric construction) can be laid open and flat as shown at FIG. 7. The elastomeric cups 50 can then be positioned in the cable pass-through pocket portions 36 as shown at FIG. 7. As depicted, the elastomeric cups 50 have been pre-filled with the gel portions 60b, but also can be filled with liquid sealant after the elastomeric cups 50 have been positioned in the cable pass-through pocket portions 36. With the elastomeric cups 50 installed in the cable pass-through pocket portions 36 as shown at FIGS. 7 and 8, the cup upper boundaries 54 are higher than the pocket upper boundaries 40 and are also higher than the channel upper boundaries 42. In the depicted example, the pocket upper boundaries 40 and the channel upper boundaries 42 are at the same level. As shown at FIGS. 7 and 8, the elastomeric cups 50) are positioned so that the side portions 74 of the cup walls 52 separate the cable pass-through pocket portions 36 from the sealing channel portion 32. With the elastomeric cups 50 in the cable pass-through pocket portions 36, the sealing channel portions 32 can be filled with liquid sealant to a level lower than the sealant in the elastomeric cups 50 and then cured to form the sealant gel 60a (see FIGS. 1 and 2). The side portions 74 of the cup walls 50 prevent the sealant from flowing from the sealing channel portions 32 into the cable pass-through pocket portions 36. In the case where the elastomeric cups 50 provide containment of liquid sealant while the elastomeric cups 50 are installed in the cable pass-through pocket portions 36, the cup walls 50 provide containment of the liquid sealant and prevent the liquid sealant from flowing into the sealing channel portions 32. In this way, the level of sealant in the elastomeric cups 50) and thus at the cable pass-through pocket portions 36 can be maintained at a higher level than the level of the liquid sealant in the sealing channel portions 32. The liquid sealant in the sealing channels 32 can be cured to set the cured sealant (e.g., the sealant gel 60a) at a lower level than the sealant in the elastomeric cups 50). In the case where the elastomeric cups 50 provide containment of liquid sealant while the elastomeric cups 50 are installed in the cable pass-through pocket portions 36, the liquid sealant in the elastomeric cups 50 can also be cured to set the sealant gel 60b at the level higher than sealant in the sealing channel portions 32.

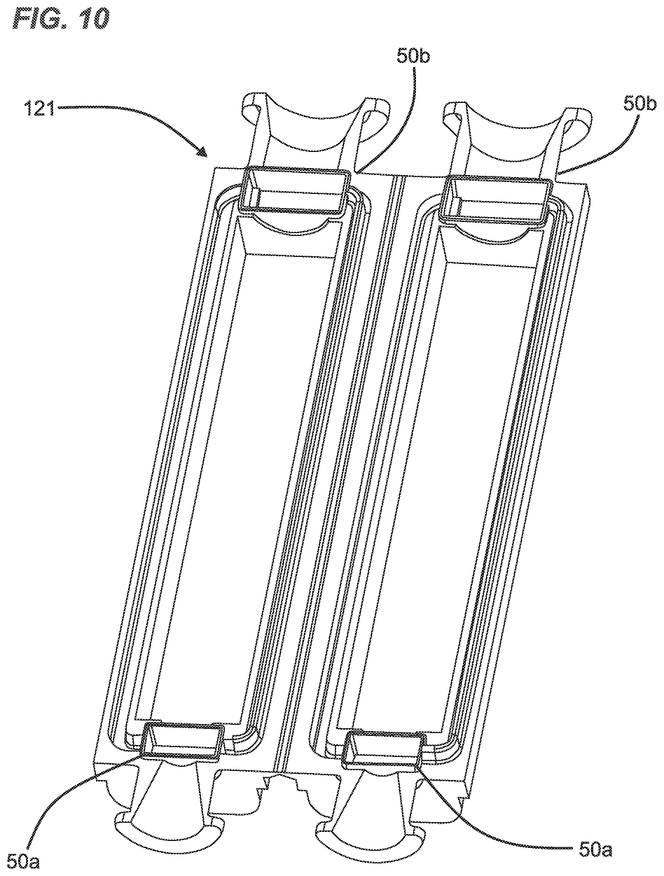

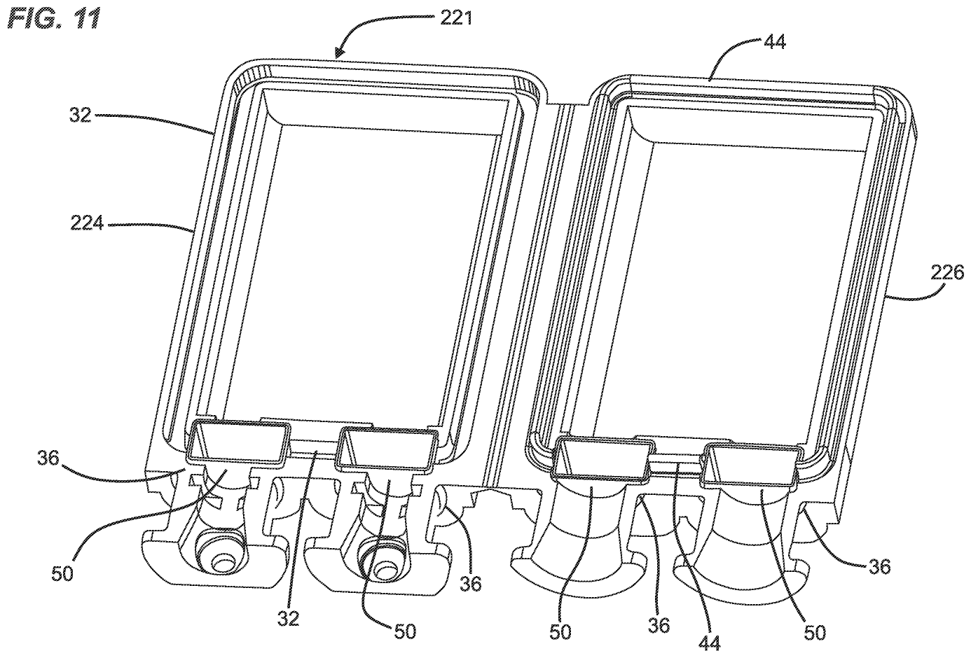

The housing 21 of FIG. 1 has an in-line configuration with cable pass-through pocket portions 36 containing the elastomeric cups 50 being located at opposite ends of the housing 21. In the example of FIG. 1, the cable pass-through pocket portions 36 and elastomeric cups 50 at opposite ends have the same size. FIG. 10 depicts an example housing 121 having an in-line configuration in which cable pass-through pocket portions of different sizes are positioned at opposite ends of the housing 121. The pocket portions are shown receiving elastomeric cups 50a, 50b having different sizes. FIG. 11 depicts an example housing 221 having a butt-style configuration in which all the cable pass-through pocket portions 36 are located at one end of the housing 221. The housing includes first and second housing pieces 224, 226 that cooperate to define an enclosed housing interior when the housing 221 is closed. In this example, cable pass-through pocket portions 36 containing elastomeric cups 50) are provided at each of the housing pieces 224, 226. However, all of the cable sealing channel portions 32 are defined by the first housing pieces 224 and all of the perimeter sealing ribs 44 are defined by the second housing pieces 226.

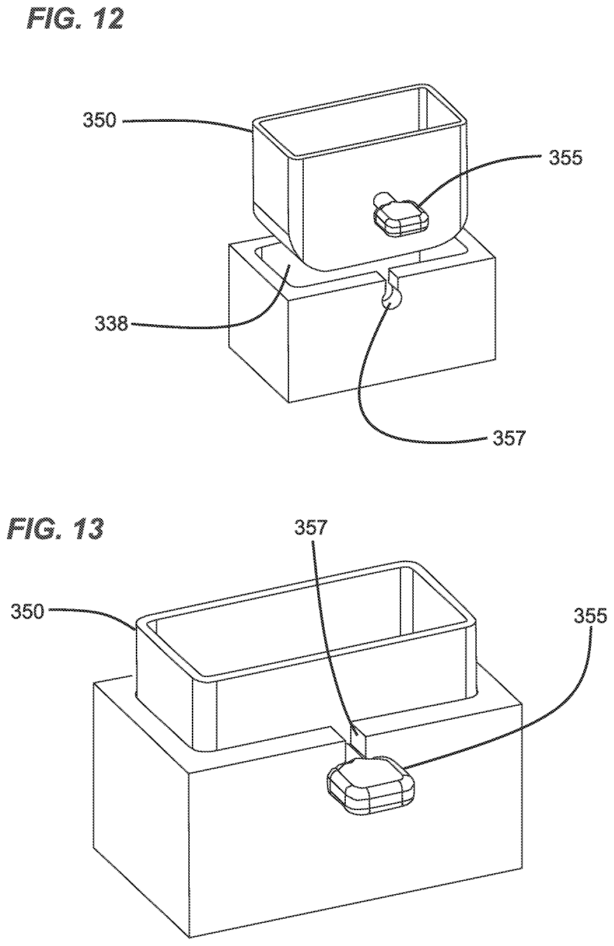

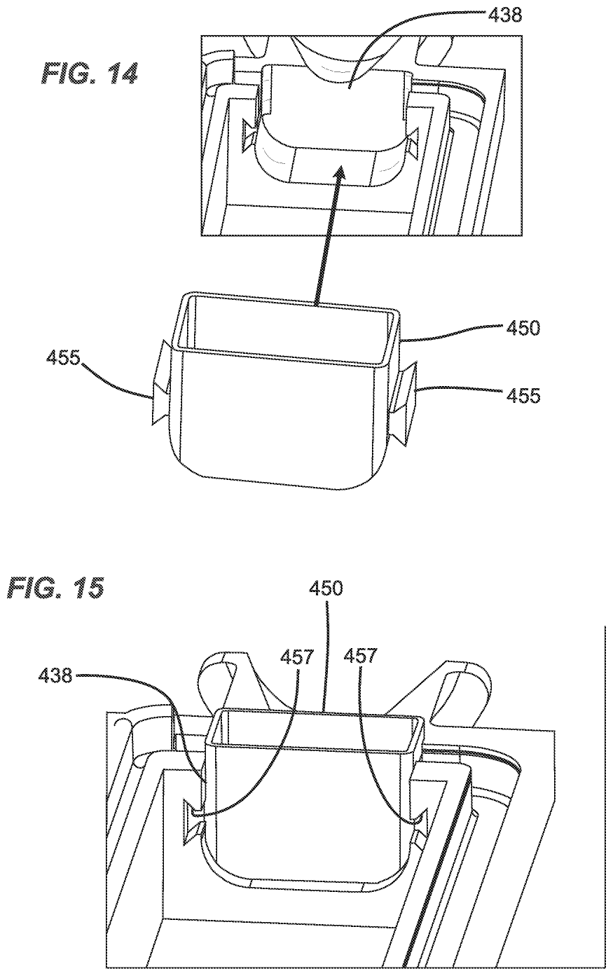

In certain examples, the elastomeric cups 50 are secured within their corresponding cable pass-through pocket portions 36. For example, the elastomeric cups 50) can be frictionally retained in the pocket portions 36, bonded within the pocket portions 36 or mechanically secured within the pocket portions 36. In the case where the elastomeric cups 50 have open bottoms and receive liquid sealant that is cured while the elastomeric cups are in the pocket portions 36 of the housing, the sealant can bond to the housing and the elastomeric cups when cured. FIGS. 12 and 13 depict an elastomeric cup 350 having a mechanical retainer/interlock such as a retention tab 355 that engages with a slot 357 of a pocket-defining portion 338 of an enclosure housing to provide retention of the elastomeric cup 350 in the pocket-defining portion 338. The slot 357 is a vertical slot that receives a stem of the tab 355 when the cup 350 is loaded downwardly into the pocket-defining portion 338. FIGS. 14 and 15 depict an elastomeric cup 450 having a mechanical retainer/interlock such as retention tabs 455 (e.g., dovetails, tongues) that engage with slots 457 (e.g., dovetail slots, grooves) of a pocket-defining portion 438 of an enclosure housing to provide retention of the elastomeric cup 450 in the pocket-defining portion 438. The slots 457 are axial slots that receives the tabs 455 when the cup 450 is loaded axially into the pocket-defining portion 438.

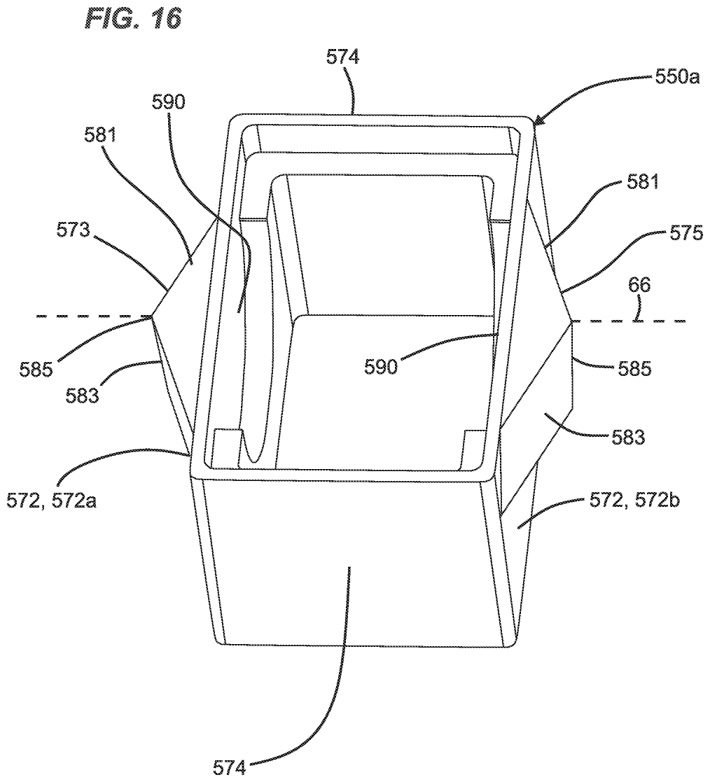

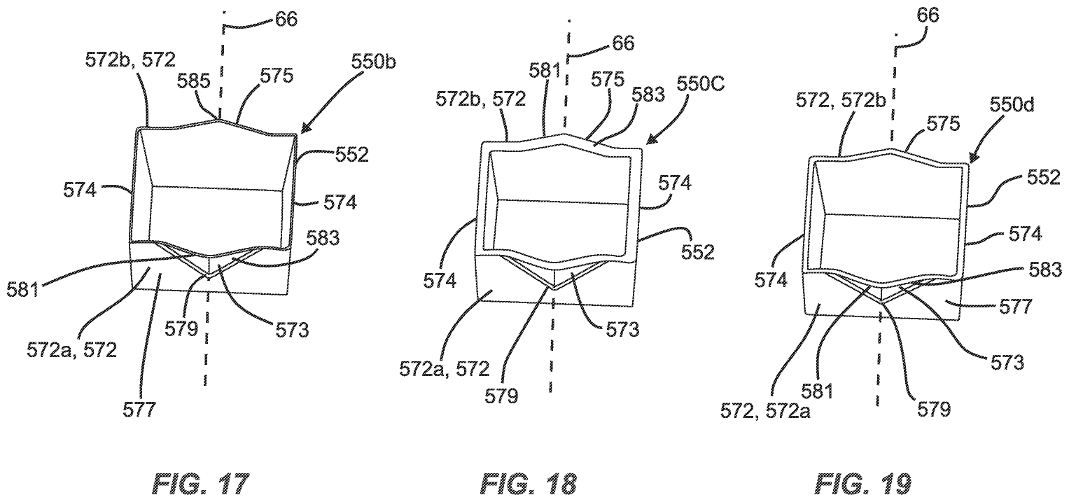

FIGS. 16-19 depict alternative elastomeric cups 550a-550d in accordance with the principles of the present disclosure. The cups 550a-550d include cup walls 552 including axial containment portions 572 and side portions 574. The axial containment portions 572 are adapted to provide axial containment of sealing gel within the cups 550a-550d and within corresponding pocket-defining portions 38 of an enclosure housing such as the housing 21. The axial containment portions 572 can be adapted to deform to accommodate cables routed through a cable pass-through location along a cable pass-through axis 66. The axial containment portions 572 can include inner containment portions 572a and outer containment portions 572b. The inner and outer containment portions 572a, 572b can be configured/contoured to encourage inward deformation (e.g., toward the inside of the housing) of the inner containment portion 572a and outward deformation (e.g., away from the inside of the housing) of the outer containment portion 572b during sealing about a cable routed along the cable pass-through axis 66. For example, inner and outer containment portions 572a, 572b can respectively have inward and outward projections 573, 575 adjacent the upper containment boundary/edge of the cup wall 552. The projections 573, 575 can be configured to contain portions of the sealant gel contained by the cups. The projections 573, 575 can have tapered configurations that converge/constrict as the tapered configurations extend away from main bodies 577 of the containment portions 573, 575. In one example, the tapered projections 573, 575 are triangular and have apexes that align with cable pass-through axis 66.

In certain examples, the cup walls 552 of the different examples 550a-550d can have different wall thicknesses designed to provide different levels of deformability and to provide different levels of elastic loading on the sealing gel contained therein when deformed during sealing. In certain examples such as the elastomeric cup 550a of FIG. 16, the cup wall 552 can include thinned wall portions 590 at the containment portions 572a, 572b for allowing the portions 590 to more easily deform to accommodate a cable during sealing. The portions 590 can be adjacent the cable pass-through axis 66. In certain examples (e.g., cups 550b-550d), the projections 573, 575 can have maximum projection dimensions adjacent the upper containment boundary of the cup wall and can gradually transition from the maximum projection dimensions to minimum projection dimensions (e.g., a zero projection dimension) at intermediate locations 579 along a height of the cup wall. In one example, projection walls 581, 583 are angled relative to one another and angled relative to the main bodies 577. The projection walls 581, 583 intersect with and are connected to the main bodies 577 at the intermediate locations 579. In one example, each set of projection walls 581, 583 meets at a ridge 585 (e.g., apex, crest).

Aspects of the present disclosure relate to cable sealing arrangements including sealing structures that readily flow from a non-deformed state to a deformed state to conform to fiber optic cables and provide effective sealing about the cables. The cable sealing structures also are preferably capable of effectively changing in shape from a deformed state to a recovered state when a cable is removed. In certain examples, the sealing structures can include a sealant that is quite soft to allow the sealant to readily and quickly conform to different sized fiber optic cables to provide effective sealing. In certain examples, the sealing structures also include structure that effectively provides containment of the soft sealing material, and has elastic properties that assists in reducing the recovery time required for the soft sealing to return to a state in which the deformation is less than 10, 5, or 2 percent. In certain examples, during sealing about a cable or cables, the containment structures (e.g., the elastomeric cups) apply pressure (e.g., elastic pressure) to the sealing gel to assist causing the sealing gel to effectively conform to exterior shape of the cable or cables to provide effective sealing.

In certain examples, sealing structures in accordance with the principles of the present disclosure, can include a hybrid or composite construction including a sealing portion (e.g., sealing gel) having a first composition and a containment portion (e.g., elastomeric cups) having a second composition. In certain examples, the first and second compositions can be compatible with one another and can be adapted to bond with respect to one another. In certain examples, the first and second compositions can both be elastomeric compositions. In certain examples, the first and second compositions can include the same base polymer. In certain examples, the sealing portion and the containment portion can both be elastomeric, but the sealing portion can be softer than the containment portion, and the containment portion can have a higher modulus of elasticity than the sealing portion. In certain examples, the containment portion can be a pre-molded structure, and the sealing portion can be molded within the containment portion. In certain examples, the sealing portion and the containment portion both have compression sets less than 10, 5, or 2 percent, but the recovery time for the containment portion is shorter than the recovery time for the sealing portion. In certain examples, the sealing material can have a gel composition, and the containment portion can have a rubber composition.

In certain examples in accordance with the principles of the present disclosure, the sealing material (e.g., gel) can have a hardness in the range of 10 to 60 Shore 000 and the material forming the elastomeric cups can have a hardness in the range of 5 to 30 Shore A. The sealing material (e.g., gel) is preferably softer than the material of the elastomeric cups. In certain examples in accordance with the principles of the present disclosure, the sealing material can have a hardness in the range of 10 to 60 Shore 000, or in the range of 5 to 25 Shore A, or in the range of 5 to 20 Shore A, or in the range of 5 to 15 Shore A, and material used for the elastomeric cups can have a hardness in the range of 5 to 40 Shore A, or in the range of 5 to 30 Shore A, or in the range of 10 to 30 Shore A, or in the range of 20 to 30 Shore A.

In certain examples, the sealing material (e.g., gel) and the elastomeric cups can each have an elastomeric construction with a base composition that includes silicone (e.g., polysiloxanes or polymethylsiloxanes). In certain examples, the sealing material and the elastomeric cups can each include an elastomeric construction with a base composition that includes a thermoplastic elastomeric. Example thermoplastic elastomers can include styrenic block copolymers, thermoplastic polyurethanes, thermoplastic copolyesters, thermoplastic polyamides, thermoplastic polyolefin elastomers, and other thermoplastic elastomers. Example sealing gels can include gels (e.g., silicone gels and other gels) of the type disclosed at PCT International Publication Number WO 2021/113109, which is hereby incorporated by reference in its entirety.

1. A method for open casting sealant for a perimeter sealing arrangement of an enclosure, the perimeter sealing arrangement including a sealant-receiving region defined by a molded plastic housing of the enclosure, the sealant-receiving region including a sealing channel portion defined by a channel-defining portion of the molded plastic housing and a cable pass-through pocket portion defined by a pocket-defining portion of the molded plastic housing, the channel-defining portion defining a channel upper boundary, the method comprising:
positioning an elastomeric cup in the cable pass-through pocket portion, the elastomeric cup including a cup wall defining a cup upper boundary that is higher than a channel upper boundary when the elastomeric cup is positioned within the cable pass-through pocket portion, wherein when the elastomeric cup is positioned within the cable pass-through pocket portion, the cup wall separates the cable pass-through pocket portion from the sealing channel portion;
filling the sealing channel portion and the elastomeric cup with liquid sealant with the liquid sealant in the elastomeric cup being filled to a level higher than the liquid sealant in the sealing channel portion, wherein the cup wall prevents the liquid sealant in the elastomeric cup from flowing into the sealing channel portion such that the liquid sealant in the elastomeric cup remains at the level higher than the liquid sealant in the sealing channel portion; and
curing the liquid sealant to set cured sealant in the elastomeric cup at the level higher than cured sealant in the sealing channel portion.

2. The method of claim 1, wherein the liquid sealant has a composition that includes silicone.

3. The method of claim 1, wherein the cured sealant includes a sealing gel.

4. The method of claim 3, where the cured sealant includes a silicone gel.

5. The method of claim 3, wherein the cured sealant has a Shore 000 hardness in the range of 10 to 60.

6. The method of claim 5, wherein the elastomeric cup has a Shore A hardness in the range of 5 to 30, is harder than the cured sealant, and has a faster recovery time than the cured sealant.

7. The method of claim 1, wherein the elastomeric cup is pre-formed prior to positioning it in the cable pass-through pocket portion.

8. The method of claim 1, wherein the elastomeric cup has a composition including silicone rubber.

9. The method of claim 7, wherein the elastomeric cup has an open bottom.

10. The method of claim 1, wherein the liquid sealant is filled in the elastomeric cup to the cup upper boundary.

11. The method of claim 10, wherein the liquid sealant is filled in the sealing channel portion to below the channel upper boundary.

12. An enclosure having a perimeter sealing arrangement, the enclosure comprising:
a molded plastic housing including first and second housing pieces that fit together to enclose an interior of the molded plastic housing, the perimeter sealing arrangement of the enclosure being configured to provide sealing between the first and second housing pieces about a perimeter of the molded plastic housing when the first and second housing pieces are fitted together, the perimeter sealing arrangement including a sealant-receiving region defined by the first housing piece, the sealant-receiving region including a sealing channel portion defined by a channel-defining portion of the first housing piece and a cable pass-through pocket portion defined by a pocket-defining portion of the first housing piece, the channel-defining portion defining a channel upper boundary, the second housing piece defining a perimeter sealing rib configured to project into the sealing channel portion of the sealant-receiving region of the first housing piece when the first and second housing pieces are fitted together;
an elastomeric cup positioned in the cable pass-through pocket portion of the sealant-receiving region, the elastomeric cup including a cup wall defining a cup upper boundary that is higher than a channel upper boundary, the cup wall being positioned to separate the cable pass-through pocket portion from the sealing channel portion; and
sealant gel positioned within the sealing channel portion and the elastomeric cup, the sealant gel in the elastomeric cup having an upper surface set at a higher level than an upper surface of the sealant gel in the sealing channel portion.

13. The enclosure of claim 12, wherein the sealant gel is a liquid-applied sealant that is cured within the sealing channel portion and the elastomeric cup to form the sealant gel.

14. The enclosure of claim 12, wherein the sealant gel includes a silicone gel.

15. The enclosure of claim 12, wherein the sealant gel is softer and has a slower recovery time than the elastomeric cup.

16. The enclosure of claim 12, wherein the elastomeric cup has a composition including silicone rubber.

17. The enclosure of claim 12, wherein the elastomeric cup has an open bottom.

18. The enclosure of claim 12, wherein the upper surface of the sealant gel in the elastomeric cup is positioned at the cup upper boundary.

19. The enclosure of claim 12, wherein the sealant gel is filled in the sealing channel portion to below the channel upper boundary.

20. The enclosure of claim 12, wherein the cup wall includes axial gel containment portions that include tapered projections that project axially from main bodies of the axial gel containment portions, the tapered projections being configured to contain portions of the sealant gel contained by the elastomeric cup.

21. The enclosure of claim 20, wherein the tapered projections are triangular and have apexes that align with a cable pass-through axis of the enclosure.
